(19) United States
(12) Patent Application Publication
(10) Pub. No.: US 2008/0056962 A1
(43) Pub. Date: Mar. 6, 2008

(54) Micro-Laboratory

(75) Inventor: Paul J. Mulqueen, Hartselle, AL (US)

Correspondence Address: LOZA & LOZA, 305 N. Second Avenue, #127, Upland, CA, 91786-6064, US

(73) Assignee: SANMINA-SCI CORP., San Jose, CA (US)

(21) Appl. No.: 11/564,820

(22) Filed: Nov. 29, 2006

Related U.S. Application Data
(60) Provisional application No. 60/823,899, filed on Aug. 29, 2006.
(60) Provisional application No. 60/829,038, filed on Oct. 11, 2006.

(51) Int. Cl. B01J 19/00

(52) U.S. Cl. 422/130

(57) ABSTRACT

A compact module capable of performing one or more laboratory tests in nano-scale and/or micro-scale structures is provided. Such compact module may be made on silicon substrates by using manufacturing techniques typically applied to electronic and/or semiconductor manufacturing/fabrication. One aspect of the invention applies curling film technology to create and link three-dimensional elements that allow miniaturization of laboratory components and functions.

### CLAIM OF PRIORITY UNDER 35 U.S.C. §119

The present Application for Patent claims priority to U.S. Provisional Patent Application No. 60/823,899 entitled “Micro-Laboratory”, filed Aug. 29, 2006, and U.S. Provisional Patent Application No. 60/829,038 entitled “Micro-Laboratory”, filed Oct. 11, 2006, both provisional applications assigned to the assignee hereof and hereby expressly incorporated by reference herein.

### FIELD

One embodiment relates to medical sampling and testing equipment and, more particular, to a compact device having micrometer-scale and/or nanometer-scale components capable of collecting, storing, and/or processing patient samples.

### BACKGROUND

Currently, medical laboratory testing involves obtaining a patient's sample (e.g., a vial of blood, saliva, urine, etc.), physically transporting the sample to either an onsite or offsite laboratory, preparing the sample for one or more tests (e.g., separating the sample into multiple smaller samples for different tests, applying reagents, filtering the sample, etc.), and analyzing the sample using one or more devices (e.g., spectral analyzer, etc.). Thus, the process of performing medical laboratory testing involves several stages and is thus time consuming and susceptible to errors along each stage.

Additionally, there are circumstances where medical laboratories are needed but are not readily available. For example, in a combat theater or the location of a catastrophic event medical test laboratories are often desirable but not readily available due to the space and the number of auxiliary devices needed to perform medical laboratory tests.

Another difficulty with conventional laboratory samples and testing is the space needed for storing the samples and housing the laboratory equipment. For example, in space-restricted environments (e.g., onboard an aircraft, ship, or space station) having more compact laboratory samples and reducing the size and/or number of laboratory equipment would be advantageous.

Thus, a way is needed to more efficiently collect and process medical samples while reducing the size and/or number of laboratory equipment needed for processing such samples.

### SUMMARY

One novel feature moves conventional laboratory tests or steps into a compact module capable of performing some or all such laboratory tests in nano-scale and/or micro-scale structures. Such compact modules may be made by using manufacturing techniques typically applied to electronic and/or semiconductor manufacturing/fabrication. One aspect of the invention applies curling film technology to create and link three-dimensional elements (also known as “pop-ups”) that allow miniaturization of laboratory components and functions.

A micro-scale laboratory device is provided comprising: (a) a sample collector for receiving a liquid sample from a patient; (b) a micro-scale reaction chamber coupled to the sample collector, the micro-scale reaction chamber for holding the liquid sample during a reaction; and/or (c) a pre-stored reagent for mixing with a portion of the liquid sample. A micro-scale filter may filter the liquid sample. An onboard microcontroller may control the processing of the liquid sample. A micro-scale pump may be coupled to the micro-scale reaction chamber to move the liquid sample into the reaction chamber. An analysis window may be provided through which a separate analyzer can measure a characteristic of the liquid sample. An onboard analyzer may analyze the processed liquid sample from the reaction chamber. Additionally, a lancet may be coupled to the sample collector for obtaining the liquid sample.

The micro-scale reaction chamber may be formed by a curling film process. For example, the micro-scale laboratory device may include a multi-layer substrate, wherein the micro-scale reaction chamber is formed from the multi-layer substrate by a curling process. The multi-layer substrate may include one or more layers that curl to form one or more micro-scale devices when another layer is etched away. The multi-layer substrate may include at least one silicon-based layer. The reaction chamber may pre-loadable with the reagent.

A small form-factor liquid sample collection and processing device is also provided comprising: (a) a multi-layer substrate; (b) a micro-scale liquid receptacle formed from the multi-layer substrate, the receptacle for holding a liquid sample for testing; (c) a micro-scale tube formed by deforming one or more layers of the multi-layer substrate, the micro-scale tube for carrying the liquid sample from the receptacle; and/or (d) a micro-scale reaction chamber coupled to the micro-scale tube and formed by deforming one or more layers of the multi-layer substrate, the micro-scale reaction chamber for holding the liquid sample during a reaction. A micro-scale pump may be coupled to the micro-scale tube to move the liquid sample through the micro-scale tube. The reaction chamber may be pre-loaded with a reagent for processing the liquid sample. A micro-scale reagent chamber may be formed by deforming one or more layers of the multi-layer substrate for holding a reagent for processing the liquid sample. Deforming one or more layers of the multi-layer substrate includes curling one or more layers of the multi-layer substrate.

A plurality of different test may be performed by various micro-devices on the collection and processing device. For instance, a second micro-scale tube may be formed by deforming one or more layers of the multi-layer substrate, the second micro-scale tube for carrying the liquid sample from the receptacle. A second micro-scale reaction chamber may be coupled to the second micro-scale tube and formed by deforming one or more layers of the multi-layer substrate, the second micro-scale reaction chamber for holding the liquid sample during a second reaction.

A method is also provided for manufacturing a disposable micro-scale laboratory on a substrate. A micro-scale receptacle is formed from the substrate for holding a liquid sample for testing. A micro-scale tube is also formed from the substrate for transferring the liquid sample from the receptacle. A micro-scale reaction chamber may be formed from the substrate, the micro-scale chamber coupled to the micro-scale tube. A micro-scale pump may be coupled to the micro-scale tube to move the liquid sample through the micro-scale tube. The substrate may include a plurality of layers, one or more layers curl to form one or more micro-scale devices when another layer is etched away. The substrate may include a silicon substrate on an etchable base substrate. A reagent may be added to the micro-scale chamber to perform specific tests on the liquid sample, a micro-scale filter may be formed from the substrate to filter the liquid sample. A lancet may also be formed from the substrate for obtaining the liquid sample. A micro-scale reaction chamber may also be formed from the substrate, the micro-scale reaction chamber coupled to the lancet to receive the liquid sample from the lancet.

### BRIEF DESCRIPTION OF THE DRAWINGS

FIG. 1 is a block diagram illustrating one embodiment of a micro-laboratory device implemented on a micro-scale silicon substrate.

FIG. 2 is a block diagram illustrating another embodiment of a micro-laboratory device implemented on a micro-scale silicon substrate.

FIG. 3 is a block diagram illustrating yet another embodiment of a micro-laboratory device that may be implemented on a micro-scale silicon substrate.

FIG. 4 illustrates a sample collection and processing device housing the micro-laboratory devices according to one example.

FIG. 5 illustrates a perspective cross-sectional view of how a micro-scale filtering grid may be formed from curling film technology on silicon.

FIG. 6 illustrates a perspective cross-sectional view of how a micro-scale reaction chamber may be formed from curling film technology on silicon.

FIG. 7 illustrates a perspective cross-sectional view of how a micro-scale tube may be formed from curling film technology on silicon.

FIG. 8 illustrates a method for manufacturing a disposable micro-scale laboratory device on a (silicon) substrate.

FIG. 9 illustrates a sample wafer layout for a strip of micro-scale reaction chambers made from a silicon substrate.

FIG. 10 illustrates an expanded view of the micro-scale reaction chambers of FIG. 9.

FIG. 11 illustrates one embodiment of a micro-scale reaction chamber.

FIG. 12 illustrates a lancet used to draw a sample from a patient.

FIG. 13 illustrates yet another embodiment of a micro-laboratory device on a micro-scale silicon substrate.

### DETAILED DESCRIPTION OF THE INVENTION

In the following detailed description of the invention, numerous specific details are set forth in order to provide a thorough understanding of the invention. However, the invention may be practiced without these specific details. In other instances, well known methods, procedures, and/or components have not been described in detail so as not to unnecessarily obscure aspects of the invention.

One novel feature moves conventional laboratory tests or steps into a compact module capable of performing some or all such laboratory tests in nano-scale and/or micro-scale structures. Such compact modules may be made by using manufacturing techniques typically applied to electronic and/or semiconductor manufacturing/fabrication. Such techniques include, for example, nano-scale and micro-scale lithography, chemical and/or mechanical planarization, etching, plasma ashing, thermal treatment (e.g., anneals, oxidation, etc.), laser cutting, layer deposition (e.g., vapor deposition, electrochemical deposition, molecular beam epitaxy, atomic layer deposition, etc.), among others. However, instead of providing just electrical devices, traces, and/or components, these techniques are also used to fabricate nano-scale and/or micro-scale laboratory devices, tubes, channels, receptacles, chambers, sensors, etc., that perform sample collection, storage, and/or processing, among other laboratory functions. Such samples may include fluids such as blood, plasma, saliva, urine, sweat, among others. Additionally, some examples may be configured to use solid or semi-solid samples to be tested.

To achieve cost efficient construction of such micro-scale devices, one configuration employs curling film technology, also known as strain architecture and roll-up nanotech, to fabricate at least some nano-scale and/or micro-scale laboratory devices.

Creating three dimensional (3D) structures on semiconductor substrates has proven a challenge to semiconductor designers and manufacturers. Conventional semiconductor fabrication technologies can use etching to form nano-scale and micro-scale three-dimensional devices or structure. However, etching three-dimensional devices on silicon-based substrates is costly since relatively thick layers are needed. That is, the cost of using a relatively thick layer and etching such layer to form the three-dimensional structure makes this etching process cost prohibitive for many applications. Moreover, certain types of shapes, such are helices, tubes, etc., are difficult or impossible to be created using etching processes.

Curling film technology allows the creation of three-dimensional structures or devices without the need for thick substrates. A first silicon layer is deposited on a soluble substrate and a second silicon layer is deposited on the first silicon layer. Because the atoms of the first silicon layer are squeezed together while the atoms of the second layer are stretched apart, they are under tension. When the substrate is etched away, the corresponding region of the first and second silicon layers curl onto the second silicon layer. That is, the atoms of the first layer expand while the atoms of the second layer contract, thereby curling. This curling film technique is discussed in “Pretty As You Please, Curling Films Turn Themselves Into Nanodevices”, Science, Vol. 313, Jul. 14, 2006, pages 164-165 by Adrian Cho.

One aspect of the invention applies curling film technology to create and link three-dimensional elements (also known as “pop-ups”) that allow miniaturization of laboratory components and functions.

FIG. 1 is a block diagram illustrating one embodiment of a micro-laboratory device 102 implemented on a micro-scale silicon substrate. A sample probe 104, such as a needle, swab, etc., is used to obtain the desired sample, blood, urine, saliva, etc., from a patient. The sample may be stored in a sample collector 106 from where a controller 108 can distribute it to other sub-components of the micro-laboratory 102. For instance, controller 108 can activate a pump 110, (e.g., piezo-electric device, etc.) that causes the sample to flow from the sample collector 106 through micro-tubes 112 and a filter 113 to a mixing or reaction chamber 114. The reaction chamber 114 may be prefilled or coated with a reagent or other chemical used to perform a particular test on the sample. In an alternative embodiment, the reagent or chemical is stored in a separate chamber 115 and mixed with the sample in the reaction chamber 114. In some configurations, the controller 108 may heat the reaction chamber 114 (e.g., by running current through a resistive element to cause a reaction.

In some embodiments, the sample from the reaction chamber 114 is then moved, via pump 116, to an onboard analyzer 118 that analyzes the sample for the desired test. Thus, a particular laboratory test may be performed substantially or completely on the micro-laboratory device 102 without the need for one or more of the conventional laboratory devices. Moreover, because the micro-laboratory device 102 is constructed at a micro-scale, the sample collected may be smaller, the amount of reagent in the reaction chamber 114 may also be less than conventional laboratory testing, and it can be stored in a smaller space than conventional sample vials. Additionally, by combining all or many of the laboratory processing steps into a single device, test times and costs can be significantly reduced.

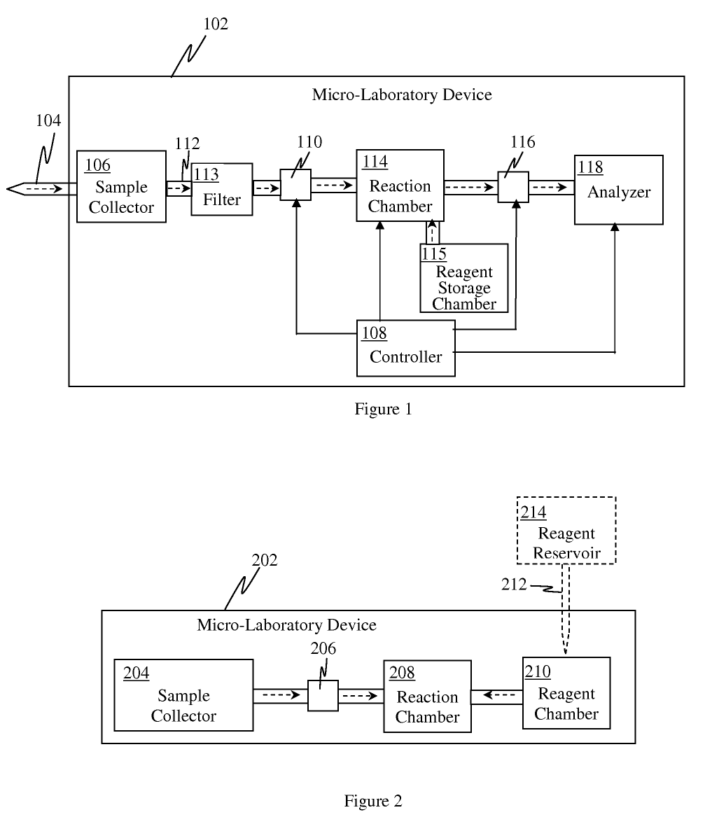

FIG. 2 is a block diagram illustrating another embodiment of a micro-laboratory device 202 implemented on a micro-scale silicon substrate. In this example, the micro-laboratory device 202 includes a sample collector 204, and a one-way valve 206 through which a collected sample flows to a reaction chamber 208. The reaction chamber 208 may be preloaded with one or more chemicals for processing the sample. In an alternative configuration, a separate reagent chamber 210 is used to store the reagent. A micro-needle 212 may be used to fill the reagent chamber 210 with a desired reagent from a reagent reservoir 214. This allows for creating an empty micro-laboratory device 202 that can be customized to particular laboratory tests on demand by adding the necessary reagents or chemicals after the device 202 is manufactured.

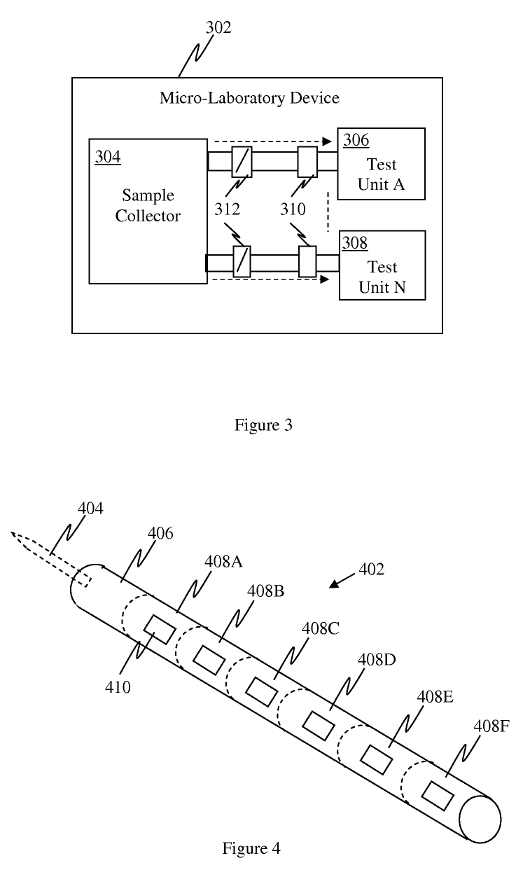

FIG. 3 is a block diagram illustrating yet another embodiment of a micro-laboratory device 302 that may be implemented on a micro-scale silicon substrate. In this example, a sample collector 304 collects and/or stores a patient's sample from where it is distributed to a plurality of test units 306 and 308. This allows multiple different tests to be performed on the collected sample at once.

In one example, valves 312 may be positioned between the sample collector 304 and the test units 306 and 308 to control the flow of a sample into the test units. The valves 312 may be activated by pressure, vacuum, heat, and/or light, for example. In another embodiment, the valves 312 may include a plug that dissolves upon contact with the sample, thereby allowing the sample to flow into the test units 306 and 308.

Additionally, a reagent chamber 310 may be located between the sample collector 304 and the test units 306 and 308 to provide a desired reagent for each type of test performed. For instance, the reagent chambers 310 may include one or more reagents in liquid, gel, and/or powder form. In one example, the reagent chambers 310 may be coated with a desired reagent during it manufacturing process (e.g., prior to curling) so that when the sample passes through the chamber, it mixes with the reagent. In another configuration, multiple reagent chambers and/or valves may be positioned in series along the patch between the sample collector 304 and the test units 306 and 308. This may permit a plurality of different reagents to be used for a particular test.

In one configuration test units 306 and/or 308 may serve as a reaction chamber where the sample and reagent mix and/or a test indicator is provided. In another configuration, the test units 306 and 308 may provide an interface (e.g., view window, etc.) through which an external analyzer may analyze the sample/reagent mixture.

FIG. 4 illustrates a sample collection and processing device 402 housing the micro-laboratory devices according to one example. Optionally, a sample probe 404, needle, swab, etc., may be attached to the device 402 to collect a patient's sample (e.g., blood, saliva, urine, etc.). The sample is drawn into a sample storage or collection unit 406 from with it can be distributed to various test units 408. Each test unit 408 may include chemicals (e.g., reagents, etc.) and/or processes associates with a different test. This allows a manufacturer to customize each individual device 402, as requested by a doctor, by inserting the requested test units in the sample collection and processing device 402. An optional analysis window 410 for each test unit 408 allows the device 402 to be inserted into a laboratory analyzer so that the processed samples in each test unit 408 can be measured or read.

In one example, an instrument holds the number of empty universal analysis chambers (UAC). Such UACs may be units (e.g., chamber 210 in FIG. 2 or test units 306 and 308 in FIG. 3) having nano-scale and/or micro-scale components that are arranged and/or configured to process, mix, and/or analyze a liquid sample. When a doctor orders a set of tests, the instrument fills the UACs with the necessary liquid reagents to perform the particular tests. This makes each UAC specific for one of the requested laboratory tests. One way to load the reagent is for the reagent wells/chambers in the UAC to be connected by a path to a one-way valve to a micro-needle. The micro-needle is connected to the bulk reagent container that delivers the reagent. A second path may be connected between the UAC and the reagent well/chamber and used to vent the air from the reagent well while the bulk reagent container fills the reagent well/chamber.

The UACs are then packaged together in a holder device (e.g., device 402 in FIG. 4). The patient sample or specimen is then introduced at one end of the holder device, such that the sample can be forced into the individual UACs (e.g., units 406) simultaneously. If the specimen is blood, the red and white blood cells may be filtered out by forcing the liquid through a filtering grid with the correct grid hole size. The filtering chamber may be big enough to hold the filtered blood cells.

The filtered specimen/sample and the reagent may be forced together thought a mixing micro-scale component. The force for such mixing may be supplied, for example, by pushing liquid out of an on-board pushing liquid chamber. The pushing liquid may be directed via active and/or passive micro-tubes to power a built-in plunger that causes the sample and/or reagent to move and/or mix. The mixing device may include a tube or chamber designed to create turbulence in the sample and/or reagent flow to cause the two to mix. The pushing liquid that moves the plunger may be moved by a thermal or electric source of energy that causes, for example, the pushing liquid chamber to contract or expand, thereby pushing the pushing liquid out. In other configurations, other means such as a built in piezo-electric pump connected to a flexible reservoir can be employed to move the sample and/or reagent.

The reagent(s) and filtered specimen are forced into the measurement chamber. Standard methods of light absorption of transmitted or reflected light, fluorescence, radiation, etc., may be employed to determine the amount of the test substance in the specimen and, thereby, provide test results. Magnetism may be used for prothrombin clotting times or direct viscosity measurements by monitoring the frequency of a piezo-electric element in the measurement chamber. Clotting will make the fluid more viscous causing amplitude and frequency shifts.

In one configuration, a micro-laboratory device is inserted into a clamshell device that may control reaction temperature and/or activation. Test readings may come from instruments built into the clamshell device thus allowing the reaction and readings to take place near the patient.

The light pipe capabilities of the curling film materials can be used to improve the sensitivity of the tests. In one example, polished inner edges of a measurement chamber are used to bounce the light multiple times through the sample before the light exits to a detector.

Using curling film technology, the described micro-laboratory devices can include various components that would otherwise be costly, inconvenient, or impossible to design in a nano-scale or micro-scale (e.g., silicon-based) module.

### Micro-Scale Filtering Grid for Samples

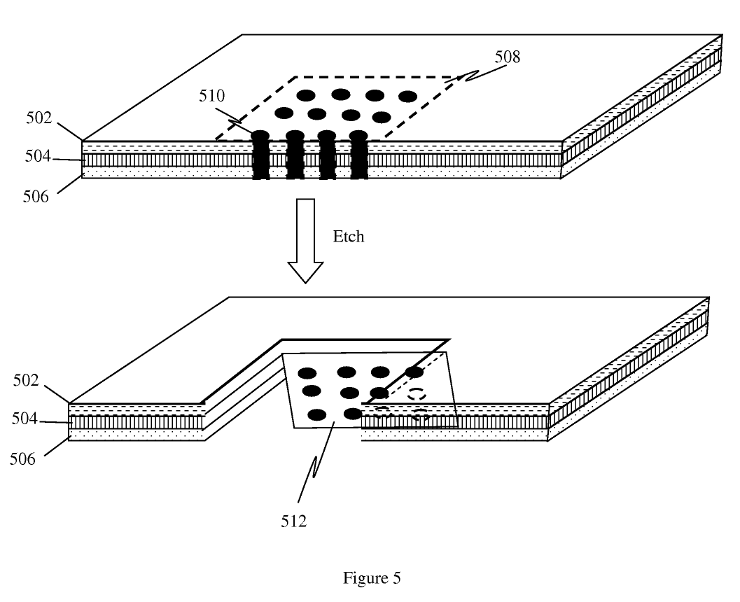

FIG. 5 illustrates a perspective cross-sectional view of how a micro-scale filtering grid may be formed from curling film technology on silicon. Filter paper or centrifugation are current used to filter (e.g., blood) samples. However, centrifugation requires a much larger sample sizes and filter paper does not have the structural strength nor uniform hole size and shape.

A first silicon layer 504 is deposited on a soluble substrate 502 and a second silicon layer 504 is deposited on the first silicon layer 504. Because the atoms of the first silicon layer 504 are squeezed together while the atoms of the second layer 506 are stretched apart, they are under tension. A portion 508 of the substrate is marked for etching and a plurality of vias 510 are formed through the substrate 502, first layer 504, and second layer 506. When the substrate portion 508 is etched away, the corresponding region of the first and second silicon layers curl or fold away into a filtering grid 512. Such grid 512 may be used as part of a micro-laboratory device to filter, for example, blood cells. The vias 510 in the grid 512 allow the plasma to flow through but not the red blood cells. The size of the vias 510 may be determined based on the substance the grid 512 is designed to filter. Such vias maybe formed using known semiconductor manufacturing processes (e.g., laser drilling, etc.) which provide highly accurate via sizing.

An alternative way of obtaining such vias 510 to form a micro-scale filtering grid is to etch the vias into the first and second layers 504 and 506 before or during the curling of the layers 504 and 506.

### Micro-Scale Reaction Chambers

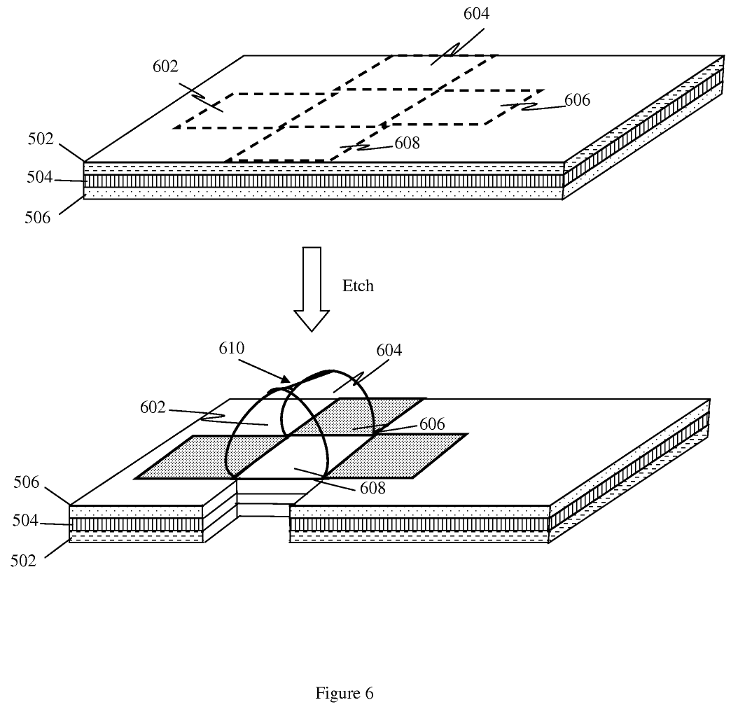

FIG. 6 illustrates a perspective cross-sectional view of how a micro-scale reaction chamber may be formed from curling film technology on silicon. In one example, such reaction chamber may be formed by defining regions 602, 604, 606, and 608 on substrate 502 that are etched away so that the first and second layer 504 and 506 curl into a pocket or chamber 610. Thus, the three-dimensional nano-scale or micro-scale reaction chamber 610 may be formed having a uniform shape. By contrast, conventional reaction chambers are large in size.

### Micro-Scale Tubes

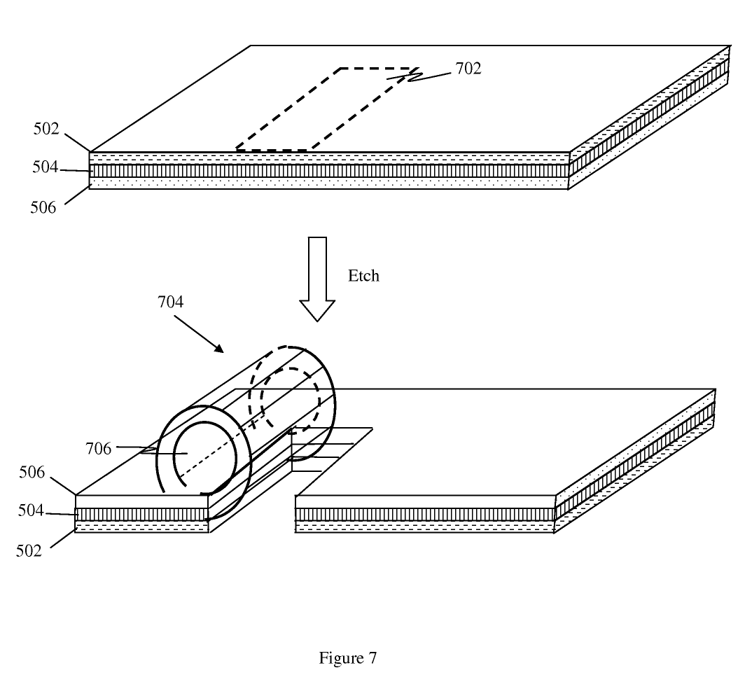

FIG. 7 illustrates a perspective cross-sectional view of how a micro-scale tube may be formed from curling film technology on silicon. In one example, such micro-scale tube may be formed by defining a region 702 on substrate 502 that is etched away so that the first and second layer 504 and 506 curl into the tube 704 and define a passage 706 through which a liquid sample can flow.

While FIGS. 5, 6, and 7 have illustrated dual silicon layers that curl when a base substrate is etched away, the present invention may be implemented using a single-layer or film that curls, folds, retracts, and/or bends when its base substrate is removed (e.g., etched).

### Manufacturing Method

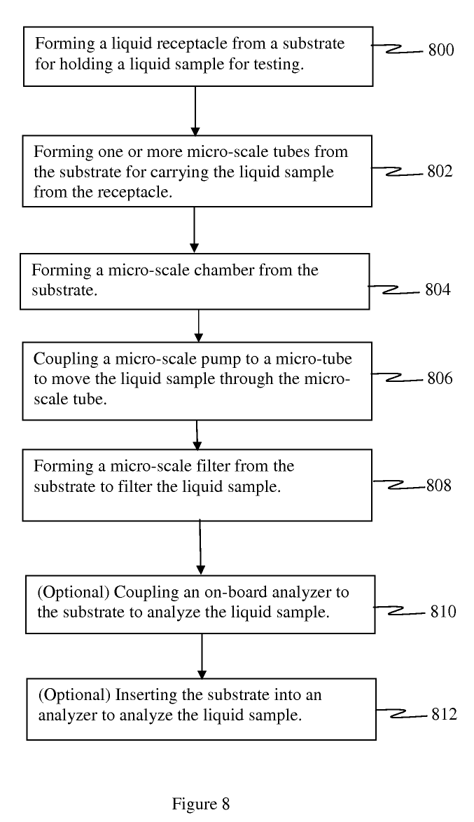

FIG. 8 illustrates a method for manufacturing a disposable micro-scale laboratory device on a (silicon) substrate. A liquid receptacle is formed from a substrate for holding a liquid sample for testing 800. One or more micro-scale tubes are formed from the substrate for carrying the liquid sample from the receptacle 802. A micro-scale chamber is also formed from the substrate 804. The chamber may include a reagent chosen to react with the liquid sample being tested. Alternatively, the chamber may serve as a reaction chamber. A micro-scale pump is coupled to a micro-scale tube to move the liquid sample through the micro-scale tube 806. The pump may include a piezo-electric device, for example. A micro-scale filter is formed from the substrate to filter the liquid sample.

In one configuration, an on-board analyzer is coupled to the substrate to analyze the liquid sample. In another configuration, the substrate is inserted into an analyzer to analyze the liquid sample.

The one or more micro-scale tubes, liquid receptacle, micro-scale chamber, micro-scale filter, and/or micro-scale pump may be formed by an etching process that removes a substrate layer thereby leaving another layer (film) to curling.

### Fluid Pump

In order to move a liquid sample through the different components of a micro-laboratory device, an active element, such as a small-scale pump may be used. For example, a source of energy, such as light or electricity may be used to cause micro-motion in a material, e.g. light to heat causing expansion, resistive heating of a metal insert, piezoelectric device with a valve, etc., such that a fluid sample is moved between two or more components. Conventional methods rely on big outside pumps, wicking, or centrifugation, all of which do not work well on the micro-scale of the present invention.

Another aspect provides for combining piezoelectric elements with curling or pop-up elements to form items such as pumps and valves to move liquid samples and/or control fluid flow.

### Vacuum Pump

Another feature may provide a vacuum pump that moves a liquid sample between two or more components of a micro-scale laboratory. The vacuum pump may create a vacuum from a micro-motion in a material, e.g. light to heat causing expansion, resistive heating of a metal insert, piezoelectric device with a valve, etc., to cause a fluid sample to be moved.

### Surface Coating

The surface of a micro-tube or reaction chamber may be coated with materials that affect the surface energy of the fluid. For example, a micro-tube may be coated to either promote or inhibit fluid flow in specific through the micro-tube.

Another feature provides for coating surfaces with molecules that dissolve into the sample or reagents. Using curling films increases the surface area on which such molecules may be deposited. Moreover, such molecules may be deposited on a layer prior to curling of the layer, thereby controlling the amount and area covered by the molecules. Additionally, through semiconductor manufacturing methods localized coatings of controlled depth can be created.

For example, the surfaces of micro-scale components may be coated with reactive chemicals that promote reactions with a sample. Using curling films would increase the surface area. The reactive chemicals may be deposited on a particular layer during the layering process. When the layer is subsequently curled (e.g., due to etching of another layer) the reactive chemical coats the inner walls of a micro-tube or reaction chamber. This process also controls the amount and area covered by the reactive chemical or catalytic molecules.

### Improved Light Reflectance

The inside of a micro-scale chamber may be coated or polished to improve reflectance of light. Such polishing or coating may be done when film is being deposited or layered (prior to curling). This allows control of a light path to implement multiple passes of light through a liquid sample to obtain more accurate sample measurements. This will allows for better determination of the concentration of particular molecules being tested.

### Curved Micro-Tubes

Another aspect of the invention allows curl film light tubes having a curved shape. Such curved light tubes allow packing light sources, detectors, and/or reaction chambers more efficiently on a micro-scale laboratory.

### Micro-Scale Needle

Another novel device that may be formed from curl film technology is a micro-scale needle that may be used to collect samples. The needle may be connected to a pump to draw the sample directly or, alternatively, by opening a valve to a vacuum device. One way to produce a needle is to roll the micro-tube at an angle over a pre-etched trench in the wafer. This results in a tube of a given diameter which at the end which is over the trench tapers towards a point.

The force on a micro-scale needle may be sensed to cause a passive valve to open to a vacuum thereby drawing the sample to a chamber.

### Prepackaging Reagents in Micro-Scale Chambers

Another feature provides for appropriate reagents or chemicals to be prepackaged into chambers of a micro-scale laboratory device. The micro-scale laboratory device would cause the correct amount of reagent and sample to mix, for the correct time, at the correct temperature.

### Customizable Prepackaged Tests Units

The prepackaged test units may be loaded by an instrument based on the physician's test order. A micro-scale laboratory device including one or more prepackaged test units may be used by a technician to draw a sample. The micro-scale laboratory device may be packaged with the test elements at time of receiving a doctor's test order. This is different from conventional laboratory tests in which samples are first drawn and then analyzed on dedicated analyzers having defined test menus.

### Auxiliary Controllers/Electronics

In one embodiment, a standalone micro-scale laboratory device contains sufficient power and electronics to read a sample without having to be placed into a “reading instrument”. Since the standalone micro-scale laboratory device is formed on silicon layers semiconductor scale substrates, this allows electronic components to be mounted on the standalone micro-scale laboratory device.

Note that the sample and reagent chambers may also serve as the measurement chamber for some tests. The walls of the paths and chambers may be pre-coated with active chemicals such as antibodies.

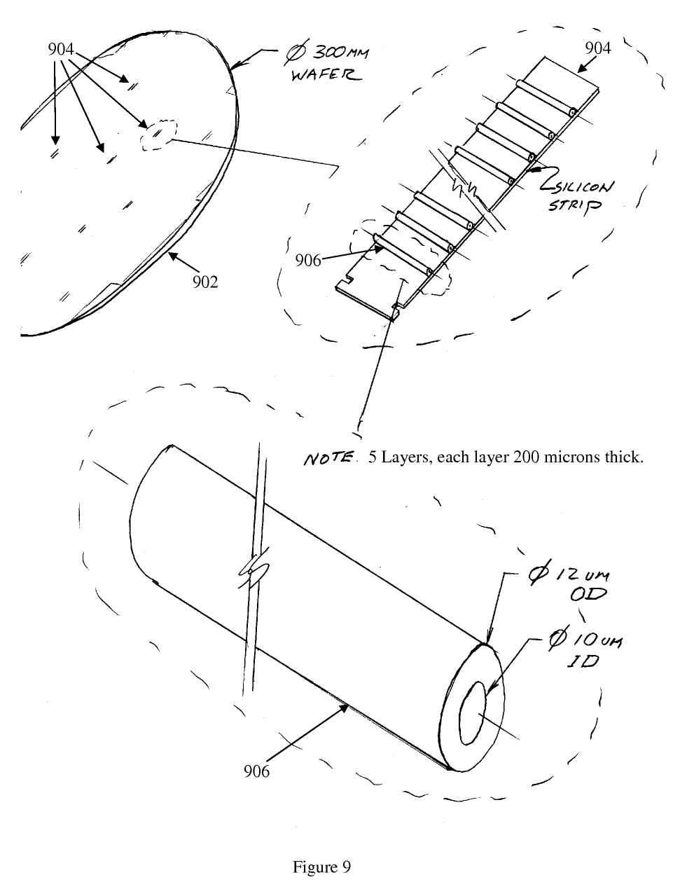

FIG. 9 illustrates a sample wafer layout for a strip of micro-scale reaction chambers made from a silicon substrate 902. The silicon substrate 902 may include a plurality of layers, as illustrated in FIGS. 5, 6, and/or 7 for example. The plurality of layers may be deposited or formed so that one or more layers (or portions of the one or more layers) curl into elements when etched, exposed, heated, or otherwise processed or activated. The size, shape, and/or arrangement of the curled elements may be selected based on the etching pattern(s), sequence of processing, and/or selection of layers.

In this example, one or more strips 904 may be formed on the wafer, with each strip including one or more micro-scaled curled elements 906. In this example, the curled elements 906 may serve as reaction chambers formed into a tube-like shape. In one example, the reaction chamber (i.e., curled element 906) may have an inner diameter of ten (10) microns and an outer diameter of twelve (12) microns and may have 1 micron thick walls formed from five (5) layers, each layer being two hundred (200) nanometers thick.

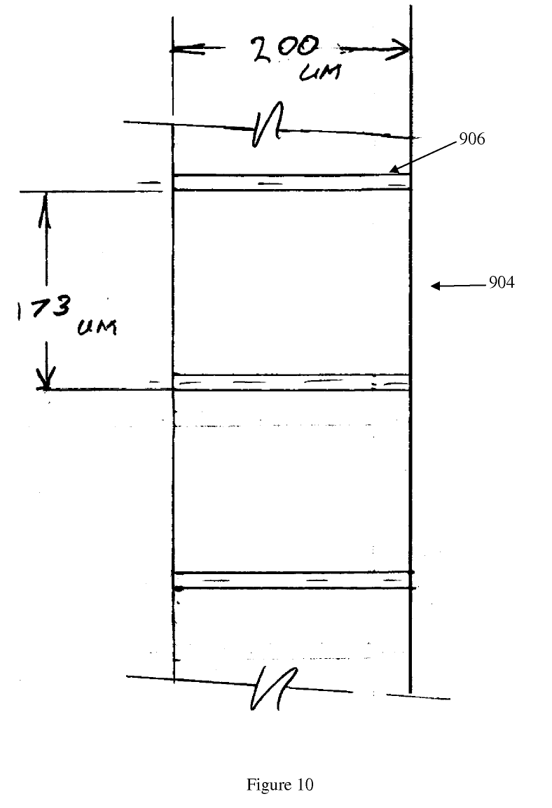

FIG. 10 illustrates an expanded view of the micro-scale reaction chambers in FIG. 9. In this example, the reaction chambers 906 on the silicon strips 904 may be two hundred (200) microns long and spaced one hundred seventy-three (173) microns apart. The dimensions and/or spacing of the reaction chambers 906 may be different depending on the particular configuration.

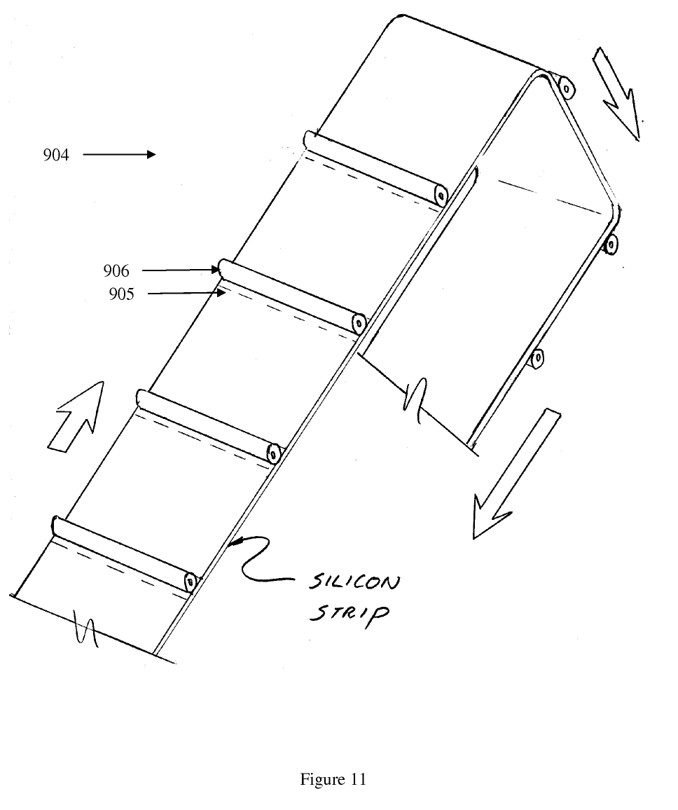

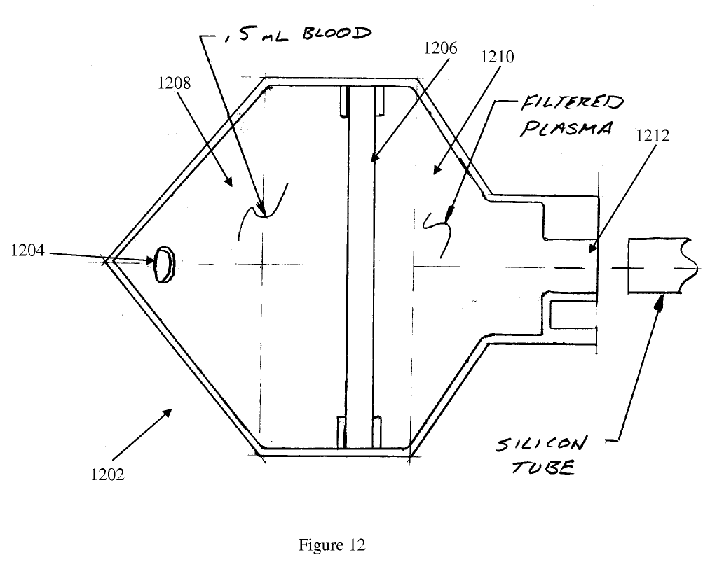

FIG. 11 illustrates how a flexible silicon strip with a plurality of micro-scale reaction chambers may be moved or rolled for processing of samples in the chambers. That is, the silicon strips 904 may be sufficiently long and are coupled to a flexible backing to allow them to bend as the strips break along scored lines 905 in a conveyor-type apparatus that moves the reaction chambers 906 from one point to another. Along the way, the reaction chambers 906 may be (A) filled with reagents (or other chemical) and/or fluid samples to be tested, (B) processed (e.g., heated, cooled, etc.), and/or (C) tested (e.g., scanned, probed or otherwise analyzed to determine one or more characteristics about the sample in the reaction chamber).

FIG. 12 illustrates a cross-sectional view of a lancet used to draw a sample from a patient according to one embodiment. The lancet 1202 may include an orifice 1204 through which a sample (e.g., blood) is drawn. In one example, the lancet 1202 may include a filter 1206 that allows some molecules (e.g., plasma) to pass from a first chamber 1208 to a second chamber 1210. The filtered molecules may then be delivered through output orifice 1212 that may couple to a tube to take the filtered sample to other components (e.g., reaction chambers, etc.). In alternative embodiments, the filter 1206 may be separate from the lancet 1202 (e.g., it may be located beyond the output orifice 1212).

### Glucose Testing Using Micro-Laboratory Device

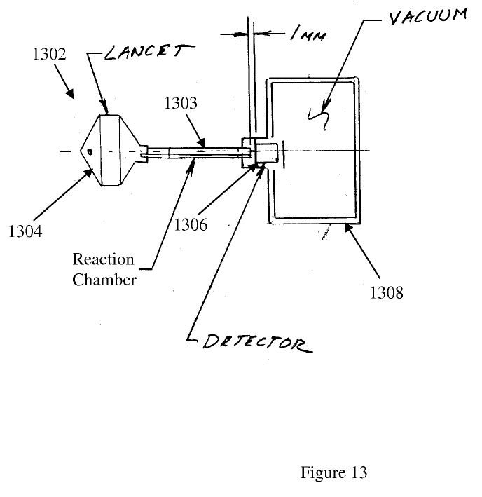

FIG. 13 shows another embodiment of a micro-laboratory device configured to test and/or analyze a fluid sample. The micro-laboratory device 1302 may include a reaction chamber 1303 (and possibly other components) that couple to a lancet 1304, a detector 1306, and a vacuum source 1308. In alternative embodiments, the lancet 1304 and vacuum source 1308 may be integral or separate from the micro-laboratory device 1302. For example, the lancet 1304 may be a micro-scale device formed using curling film technology and coupled to the reaction chamber. The micro-laboratory device 1302 may be configured to be used with a handheld apparatus (that includes a detector/analyzer 1306, and/or a vacuum source 1308) that tests an extracted sample in the micro-laboratory device 1302.

In one configuration, the micro-laboratory device 1302 may be used to extract a blood sample (using the lancet 1302) and take a subsequent glucose reading of the extracted blood sample. In this example, the micro-laboratory device may include a micro-scale lancet 1304 and a reaction chamber 1303. The micro-laboratory device 1302 may be a disposable item in which the lancet 1304 and reaction chamber 1303 are disposed of after one use. The micro-laboratory device 1302 is coupled to a meter (e.g., detector/analyzer 1306 and/or vacuum source 1308). The lancet 1304 and/or reaction chamber 1303 may be stand-alone devices or part of a strip having multiple micro-laboratory devices 1302.

To operate, a new micro-laboratory device 1302 (e.g., lancet 1304 and reaction chamber 1303) is coupled or inserted into a meter or analyzer. An operator may rub the arm of the patient to bring blood to the surface, and then prick the area to be sampled with the lancet 1304. FIG. 12 illustrates one configuration for a lancet and micro-filter. The sample taken from the patient is drawn into an orifice or small holes at the tip of the lancet 1304. A chamber inside of the lancet tip may be sufficiently large to store a blood sample size of 0.5 microliter, for example. A micro-filter may self-contained in the lancet tip with ample surface area to allow for the blood sample to be filtered. With the assistance of a vacuum pump, the resulting plasma (about 0.2 μl) is channeled from the lancet 1304 to the reaction chamber 1303 (see example in FIG. 9). The reaction chamber 1303 may be pre-loaded with enzymes and/or reagents used for a particular test. Once the filtered blood or plasma from the lancet 1304 re-hydrates the enzyme and reagents in the reaction chamber 1303, the content of the reaction chamber may be analyzed. For example, a photo diode may detect the light emitted which could be compared to a calibration curve for glucose to provide an indication of the characteristics of the measured blood sample.

The lancet 1304 may then be ejected and the micro-scale reaction chamber 1303 can be advanced on the strip and moved off to a collection area (FIG. 11). The meter is now ready to accept a new lancet and reaction chamber for the next measurement.

### Example Application Chemistry

The volume of the reaction chamber (e.g., chamber 1303 in FIG. 13) should be large enough to release a detectable amount of energy. Assuming the reaction chamber's inner diameter is 10 μm and it is more than 200 μm long, the tube is filled to the 200 μm point. This requires a volume of plasma equal to:

V=200 μm*π*5 μm²

V=15,708 μm³

V=15,708 μm³*(1 μl/10⁹ μm³)=1.57*10⁻⁵ μl

### Clearly 0.2 μl of plasma is vastly more than needed to fill a micro-lab tube or reaction chamber 1303.

A normal concentration for glucose in the plasma is 5 mmol/l with a range from 1.1 to 34.7 mmol/l. The amount of glucose in the plasma can be determined using the well established glucose oxidase-peroxidase system linked to Luminol. This reaction produces light in proportion to the amount of glucose in the sample. The enzyme and reagents may be stored dried in the interior of the micro-tube using standard techniques. It is not necessary to immobilize the glucose oxidase enzyme. Upon entering the reaction chamber, the plasma re-hydrates the enzyme and reagents.

In order to determine the number of photons per second that can conservatively be expected from the micro-tube or reaction chamber, the number of glucose molecules in a 5 mmol/l solution of 1.57*10⁻⁵ μl volume is determined.

Glucose molecules=(5*10⁻³ mole/l)*(1.57*10⁻¹¹ l)*(6*10²³ molecules/mole)

Glucose molecules=4.71*10¹⁰ molecules

Since Luminol has a quantum yield of approximately 0.25 there will be 1 photon for every 4 molecules of glucose.

Number of photons=Y=1.2*10¹⁰

The concentration of the reagents may be configured to consume about 60% of the glucose in 10 seconds, using standard enzyme kinetics. Approximately half of the photons will reflect off the inner walls toward the lancet tip and the other half will move toward the meter or detector. Therefore, the meter or detector may be provided with approximately 3.6*10⁸ photons per second.

### Example Application Photo Diode

To ensure a cost effective method for detecting the reaction energy, a common photo diode may be used. To determine the minimum resolution possible with a photo diode, the Noise Equivalent Power (NEP) is used and is given by:

$$NEP [ W / \sqrt{HZ} ] = \frac{NoiseCurrent [ A / \sqrt{H z} ]}{PhotoSensitivity [ A / W ]}$$

Since the chemical reaction used for glucose emits photons at 430 nm, the energy in a single photon was found to be 4.619×10⁻¹⁹ J per photon, by the following equation (where h is Planck's constant, c is the speed of light in a vacuum, and λ is the wavelength):

$$Energy per photon = \frac{hc}{λ}$$

The chemical reaction considered above emits approximately 3.6×10⁸ photons per second at concentrations of 5 mmol/l. The typical photo diode has a reactivity (R) of 0.14 Amps/Watt at 430 nm, the NEP is found to be 12.8 pW. The amount of light power available is 4.619×10⁻¹⁹ J per second*3.6×10⁸ photons per second and when scaled to the solution concentrations of 3.6 mmol/l to 5.8 mmol/l is between 119 pW to 192 pW. The light power available is within the detectable bounds.

One or more of the components, steps, and/or functions illustrated in FIGS. 1, 2, 3, 4, 5, 6, 7, 8, 9, 10, 11, 12, and/or 13 may be rearranged and/or combined into a single component, step, or function or embodied in several components, steps, or functions without affecting the. Additional elements, components, steps, and/or functions may also be added without departing from the invention.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A micro-scale laboratory device comprising:
a sample collector for receiving a liquid sample from a patient;
a micro-scale reaction chamber coupled to the sample collector, the micro-scale reaction chamber for holding the liquid sample during a reaction, and
a pre-stored reagent for mixing with a portion of the liquid sample.

2. The device of claim 1 further comprising:
a micro-scale filter for filtering the liquid sample.

3. The device of claim 1 further comprising:
a microcontroller for controlling the processing of the liquid sample.

4. The device of claim 1 further comprising:
a micro-scale pump coupled to the micro-scale reaction chamber for moving the liquid sample into the reaction chamber.

5. The device of claim 1 further comprising:
an analysis window through which a separate analyzer can measure a characteristic of the liquid sample.

6. The device of claim 1 further comprising:
an onboard analyzer to analyze the processed liquid sample from the reaction chamber.

7. The device of claim 1 further comprising:
a lancet coupled to the sample collector.

8. The device of claim 1 wherein the micro-scale reaction chamber is formed by a curling film process.

9. The device of claim 1 further comprising:
a multi-layer substrate, wherein the micro-scale reaction chamber is formed from the multi-layer substrate by a curling process.

10. The device of claim 9 wherein the multi-layer substrate includes one or more layers that curl to form one or more micro-scale devices when another layer is etched away.

11. The device of claim 9 wherein the multi-layer substrate includes at least one silicon-based layer.

12. The device of claim 1 wherein the reaction chamber is pre-loadable with the reagent.

13. A small form-factor liquid sample collection and processing device comprising:
a multi-layer substrate;
a micro-scale liquid receptacle formed from the multi-layer substrate, the receptacle for holding a liquid sample for testing;
a micro-scale tube formed by deforming one or more layers of the multi-layer substrate, the micro-scale tube for carrying the liquid sample from the receptacle; and
a micro-scale reaction chamber coupled to the micro-scale tube and formed by deforming one or more layers of the multi-layer substrate, the micro-scale reaction chamber for holding the liquid sample during a reaction.

14. The device of claim 13 further comprising:
a micro-scale pump coupled to the micro-scale tube to move the liquid sample through the micro-scale tube.

15. The device of claim 13 wherein the reaction chamber is pre-loaded with a reagent for processing the liquid sample.

16. The device of claim 13 further comprising:
a micro-scale reagent chamber formed by deforming one or more layers of the multi-layer substrate for holding a reagent for processing the liquid sample.

17. The device of claim 13 wherein deforming one or more layers of the multi-layer substrate includes curling one or more layers of the multi-layer substrate.

18. The device of claim 13 further comprising:
a second micro-scale tube formed by deforming one or more layers of the multi-layer substrate, the second micro-scale tube for carrying the liquid sample from the receptacle; and
a second micro-scale reaction chamber coupled to the second micro-scale tube and formed by deforming one or more layers of the multi-layer substrate, the second micro-scale reaction chamber for holding the liquid sample during a second reaction.

19. A method for manufacturing a disposable micro-scale laboratory on a substrate, comprising:
forming a micro-scale receptacle from the substrate for holding a liquid sample for testing;
forming a micro-scale tube for transferring the liquid sample from the receptacle; and
forming a micro-scale reaction chamber from the substrate, the micro-scale chamber coupled to the micro-scale tube.

20. The method of claim 19 further comprising:
coupling a micro-scale pump to the micro-scale tube to move the liquid sample through the micro-scale tube.

21. The method of claim 19 wherein the substrate includes a plurality of layers, one or more layers curl to form one or more micro-scale devices when another layer is etched away.

22. The method of claim 19 further comprising:
adding a reagent to the micro-scale chamber.

23. The method of claim 19 further comprising:
forming a lancet from the substrate for obtaining the liquid sample; and
forming a micro-scale reaction chamber formed from the substrate, the micro-scale reaction chamber coupled to the lancet to receive the liquid sample from the lancet.

24. The method of claim 19 wherein the substrate is a silicon substrate on an etchable base substrate.

25. The method of claim 19 further comprising:
forming a micro-scale filter from the substrate to filter the liquid sample.
